(19) United States
(12) Patent Application Publication
(10) Pub. No.: US 2010/0147508 A1
(43) Pub. Date: Jun. 17, 2010

(54) Wrap-On Reactive Element Barrier Packer and Method of Creating Same

(75) Inventor: Anthony P. Foster, Katy, TX (US)

Correspondence Address: Shawn Hunter / Baker Hughes Filings, P.O. Box 270110, Houston, TX, 77277-0110, US

(73) Assignee: Baker Hughes Incorporated, Houston, TX (US)

(21) Appl. No.: 12/696,166

(22) Filed: Jan. 29, 2010

Related U.S. Application Data
(62) Division of application No. 12/134,559, filed on Jun. 6, 2008.
(60) Provisional application No. 60/933,471, filed on Jun. 6, 2007.

(51) Int. Cl. E21B 33/12; B29C 65/02; B29C 65/48; B29C 65/18; B65H 81/00

(52) U.S. Cl. 166/118; 156/307.1; 156/192

(57) ABSTRACT

Systems and methods for installing an elastomeric element onto a packer mandrel or other existing oil field tubular equipment. In particular aspects, the packer device has a swellable elastomeric packer element.

### CROSS-REFERENCE TO RELATED APPLICATIONS

This application is a divisional of U.S. patent application Ser. No. 12/134,559 which was filed Jun. 6, 2008 and which claims the priority of U.S. Provisional Patent Application Ser. No. 60/933,471 filed Jun. 6, 2007.

### BACKGROUND OF THE INVENTION

1. Field of the Invention

The invention relates to packer devices. In particular aspects, the invention provides devices and methods for securing a packer element to a packer mandrel.

2. Description of the Related Art

Packers are used to create a fluid seal within a wellbore between a tool string and the wellbore wall. Packer devices incorporate elastomeric sealing elements that surround a central mandrel. Particular variations of these packers are those that employ elements that respond to the surrounding well fluids and swell to form a seal. The packer device is incorporated into a wellbore toolstring and disposed into the wellbore. When the packer is to be set, the packer element is extruded or expanded radially, as is known in the art, to contact and form a seal against the wellbore wall.

In certain situations, there are problems with timely delivery and cost associated with conventional packer elements because of the limited number of manufacturers capable of making the parts and delays associated with material procurement and processes required to manufacture the conventional packers. One way of mitigating manufacturing lead time and costs is to create vulcanized or cured rubber sleeves that can be slid over a mandrel, which, in this case, could be any existing oilfield tubular equipment, and adhered directly. The inner diameter of the cured sleeve is sized to form to the outer diameter of the mandrel, and with a cured sleeve of the rubber element, the strength of the rubber requires the assistance of machinery to allow the sleeve of rubber to be slid over the end of the mandrel to the desired position. The inventor has observed that a packer sealing or barrier element formed of an elastomer that expands or swells upon contact with wellbore fluids can be adhered directly to a mandrel or other existing oil field tubular equipment without the use of assisting machinery by wrapping a helically-cut, cured sleeve of rubber around the desired position of the mandrel. If the element is merely slipped onto the mandrel from an end, in the manner of a continuous cylindrical sleeve, any adhesive can be wiped off, possible resulting in a poor bond of the packer element to the mandrel. Wrapping a helically cut sleeve over the area prepared with adhesive would eliminate the wiping effect created by a solid sleeve in addition to eliminating the need for assisting machinery.

### SUMMARY OF THE INVENTION

The invention provides systems and methods for installing an elastomeric element onto a packer mandrel or other existing oil field tubular equipment. In particular aspects, the invention relates to the assembly of a packer device having a swellable elastomeric packer element.

### BRIEF DESCRIPTION OF THE DRAWINGS

The structure and operation of the invention will be more readily understood with reference to the following drawings, which are illustrative thereof and among which like components are numbered with like reference numerals:

FIG. 1 illustrates an exemplary curing mandrel having elastomeric material applied to it.

FIG. 2 depicts removal of cured elastomer from the curing mandrel.

FIG. 3 illustrates the operation of applying the cured elastomer to a packer mandrel.

FIG. 4 illustrates an exemplary operation for disposing an uncured elastomer upon a packer mandrel.

FIG. 5 depicts an exemplary technique for curing uncured elastomer upon the packer mandrel using curing wraps.

FIG. 6 depicts that arrangement shown in FIG. 5 now with an exemplary heating source applied.

### DETAILED DESCRIPTION OF THE PREFERRED EMBODIMENTS

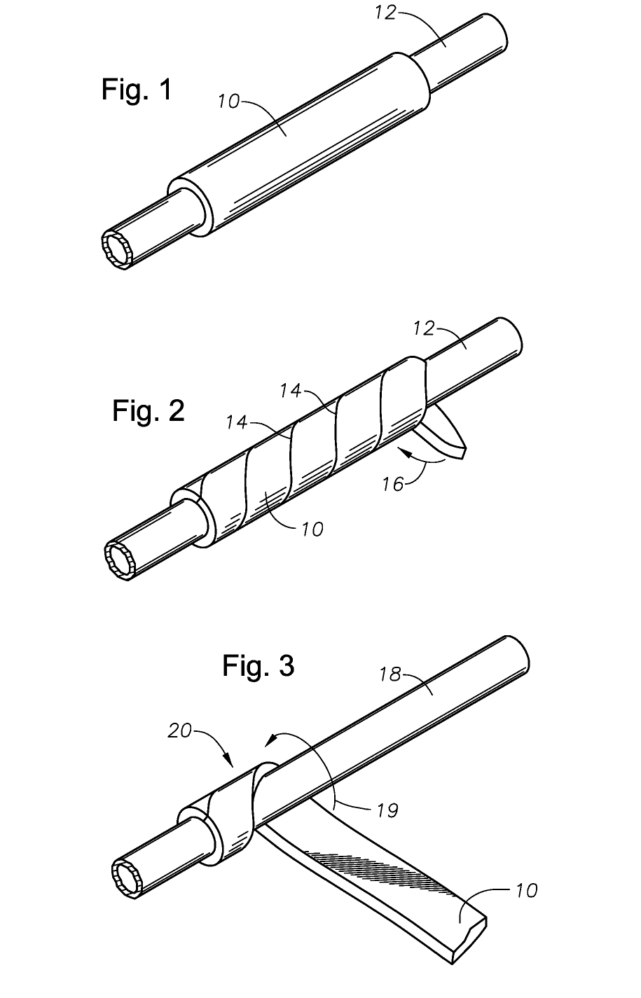

In accordance with an embodiment of the present invention, uncured elastomer 10 is disposed onto a generally cylindrical curing mandrel 12 of desired size, as illustrated in FIG. 1. These rubbers or elastomers are of the type that will swell in response to contact with fluids of the type found within a wellbore. No bonding material is used between the curing mandrel 12 and the elastomer 10. The elastomer 10 is then cured in place on the curing mandrel 12 in a manner known in the art. Upon completion of curing, the cured elastomer 10 is then removed from the curing mandrel 12. In a preferred embodiment, the cured elastomer 10 is removed by first cutting through the elastomer 10. It is further preferred that the cuts 14 form a spiral or helical pattern so that the cured elastomer that is to be removed is in a substantially helical pattern. The elastomer 10 is then unwrapped from the curing mandrel 12 as indicated by the arrow 16 in FIG. 2.

The cured elastomer 10 is then applied and secured to the outer radial surface of a generally cylindrical packer mandrel or other tubular oilfield equipment 18, as depicted in FIG. 3. It is noted that the packer mandrel 18 preferably has the same or similar diameter to that of the curing mandrel 12 so that the elastomer 10 can be wrapped onto the packer mandrel 18, as in the direction depicted by arrow 19 in FIG. 3, and form a complete and substantially intact cylinder without discontinuities. Preferably, a bonding agent is used to help bond the elastomer 10 to the packer mandrel 18. In a currently preferred embodiment, the bonding agent comprises a suitable epoxy. A heated liquid elastomer is preferably also applied to the seams corresponding to the cuts 14 previously made in the elastomer 10 to adhere the cuts/seams 14 together and integrate the elastomer 10. The elastomer 10 is preferably then retained in place upon the packer mandrel 18 using clamps or similar means while the bonding agent sets and dries. Once the bonding agent has adequately set and cured, the completed packer device can be run into a wellbore in a manner that is known in the art.

It is preferred to use the system and method of the present invention with elastomers that are reactive or swell in response to wellbore fluids. With packers that incorporate such reactive or swellable elastomer, it is desired to have the packer element 10 secured to the packer mandrel 18 along substantially the entire axial length of the packer element 10 and about the entire circumference of the interface between the packer mandrel 18 and the packer element 10. A barrier packer 20 is created that is reactive to fluids within the wellbore.

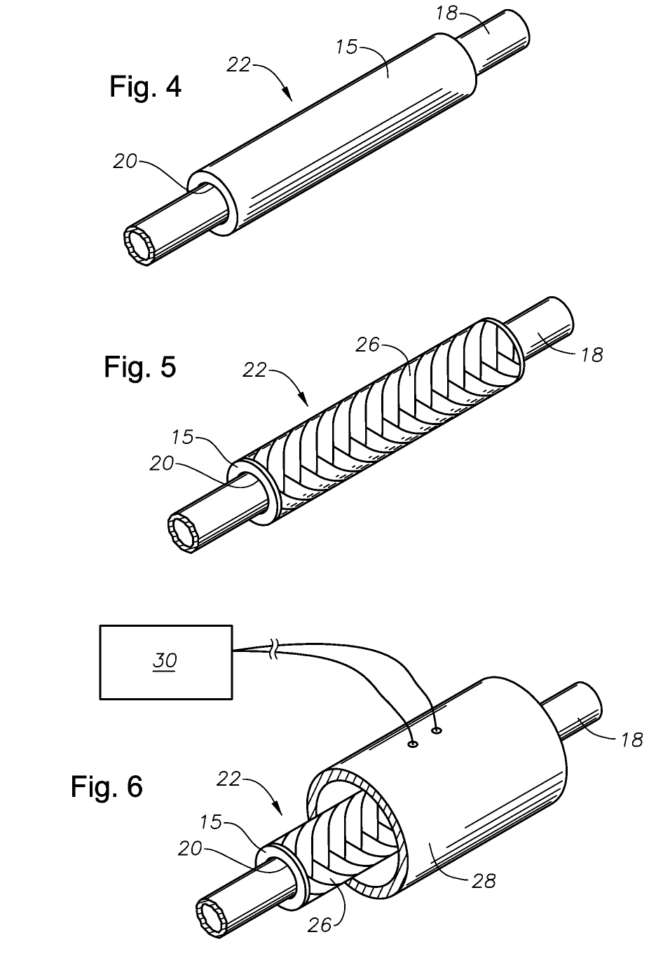

In a variation of the system and method of the invention, the elastomer 10 is put on a rubber mill and cut into long strips or extruded into an uncured cylindrical pre-form 15 using a rubber extruder and appropriately formed extruder die, as is known in the art. A curing mandrel 12 is not needed for the application of uncured rubber. For the case of uncured strips of rubber, the elastomer 10 is wrapped around the desired area of the packer mandrel 18, already prepared with an appropriate bonding agent in the manner described for the mandrel 18 below. For the case of an uncured, extruded cylindrical pre-form 15, the uncured pre-form 15 is placed onto the surface of the packer mandrel 18, as depicted in FIG. 4. It is noted that the mandrel 18 has already been prepared with an appropriate bonding agent in the same manner as for the uncured rubber strips. For the case of the extruded cylindrical pre-form 15, the interior diameter 20 of the pre-form would to be adequately large enough to permit the pre-form 15 to easily slide over the pipe mandrel 18 to the approximate location prepared with the bonding agent without wiping the bonding agent from the surface of the mandrel 18.

Curing is then conducted upon the assembled packer assembly 22. One currently preferred method of curing the elastomer 15, as illustrated in FIG. 5, is to wrap curing wraps 26 around the uncured elastomer 15. Curing wraps 26 are usually a film or tape, typically fashioned from nylon, with a significant shrinkage of approximately 7% to 11% that occurs during the curing process. The curing wraps 26 may be wrapped over the uncured elastomer 15 in an overlapping spiral pattern known to those familiar with rubber wrapping processes, although other suitable wrapping patterns may be used. During curing of the elastomer 15, the curing wraps 26 shrink, which applies a significant radially-inward compressive load to the elastomer 15 that is curing underneath. A heating source, such as a band heater 28, of a type known in the art, is then disposed over the curing wraps 26. FIG. 6 illustrates the packer device 22 now disposed within an annular band heater 28 to cause the elastomer 15 to be cured by applied heat. The band heater 28 is activated by a power source 30 to cure the elastomer 15. As the uncured elastomer 15 heats up during the cure cycle, any spaces or voids will knit together and close from the vulcanization. The bonding agent will activate and begin bonding the curing elastomer 15 to the mandrel 18. The length of the curing cycle will be determined by the thickness of the elastomer 15 being cured. Generally, the curing process requires that the elastomer be maintained at a temperature of about 300° to about 320° F. for around 1.5 hours. Heat may alternatively be applied by any of a number of known heating sources, including, for example, heating blankets similar to those used for annealing welds on large pieces, as is known in the art. Alternatively, the elastomer 10 may be cured using a specialized mobile molding unit, of a type know to those of skill in the art. Where a mobile. molding unit is used for the curing process, curing wraps 26 are not necessary to the curing process.

In a related aspect, the invention contemplates preparation of the packer mandrel 18 prior to affixing the elastomer 10 thereto. The packer mandrel 18 is preferably prepared by sandblasting, grinding, or buffing with sand paper or a similar abrasive material to remove rust and scale from the outer radial surface of the packer mandrel 18. It is then cleaned with a solvent to remove oils and other chemicals. Then, a primer and bonding agent for uncured rubber or an epoxy for the cured rubber is applied to the area. Finally, the elastomer 10 is wrapped over the mandrel 18 prior to curing. In the case of a cured piece of rubber, the rubber is wrapped over the epoxy.

Those of skill in the art will recognize that numerous modifications and changes may be made to the exemplary designs and embodiments described herein and that the invention is limited only by the claims that follow and any equivalents thereof.

What is claimed is:

1. A method of assembling a packer device comprising:
disposing a section of uncured elastomer upon a packer mandrel, the elastomer being swellable in response to wellbore fluids; and
curing the elastomer.

2. The method of claim 1 wherein the step of curing the elastomer further comprises wrapping the uncured elastomer with curing wraps.

3. The method of claim 1 wherein the step of curing the elastomer comprises applying heat to the uncured elastomer from a heat source.

4. The method of claim 3 wherein the heat source comprises a band heater.

5. The method of claim 1 further comprising the step of securing the elastomer to the packer mandrel with a bonding agent.

6. The method of claim 3 wherein the heat source is a mobile molding unit.

7. The method of claim 1 wherein the step of disposing a section of uncured elastomer upon a packer mandrel further comprises sliding a cylindrical pre-form sleeve over the packer mandrel.

8. A method of assembling a packer device comprising:
disposing a section of uncured elastomer upon a packer mandrel by sliding a cylindrical pre-form sleeve onto the packer mandrel, the elastomer being swellable in response to wellbore fluids; and
curing the elastomer.

9. The method of claim 8 wherein the step of curing the elastomer further comprises wrapping the uncured elastomer with curing wraps.

10. The method of claim 8 wherein the step of curing the elastomer comprises applying heat to the uncured elastomer from a heat source.

11. The method of claim 10 wherein the heat source comprises a band heater.

12. The method of claim 8 further comprising the step of securing the elastomer to the packer mandrel with a bonding agent.

13. A packer device formed by:
disposing a section of uncured elastomer upon a packer mandrel, the elastomer being swellable in response to wellbore fluids; and
curing the elastomer.

14. The packer device of claim 13 wherein the section of uncured elastomer further comprises a cylindrical pre-form sleeve.

15. The packer device of claim 13 wherein the elastomer is further secured to the packer mandrel with a bonding agent.

16. The packer device of claim 13 wherein the step of curing the elastomer comprises applying heat to the uncured elastomer from a heat source.

17. The packer device of claim 16 wherein the heat source comprises a band heater.

18. The packer device of claim 13 wherein the step of curing the elastomer further comprises wrapping the uncured elastomer with curing wraps.
